(19) United States
(12) Patent Application Publication
(10) Pub. No.: US 2026/0166698 A1
(43) Pub. Date: Jun. 18, 2026

(54) SETTING TOOL

(71) Applicant: RHEFOR GbR, Berlin (DE)

(72) Inventor: Arno Mecklenburg, Berlin (DE)

(21) Appl. No.: 18/577,949

(22) PCT Filed: Jul. 8, 2022
(86) PCT No.: PCT/EP2022/069084

§ 371 Date: Nov. 26, 2024

(30) Foreign Application Priority Data
Jul. 10, 2021 (DE) 10 2021 003 535.6

(51) Int. Cl. B25C 1/06; H02G 11/00

(52) U.S. Cl. CPC B25C 1/06; H02G 11/003

(57) ABSTRACT

A setting tool, comprising: at least one housing and an electrodynamic drive, wherein the electrodynamic drive comprises at least: a first excitation coil; a movable electrical conductor, for example a squirrel-cage rotor or a second coil, which is arranged movably in the setting tool; a driving-in element; a cable; a tensioning device for the at least one cable, comprising at least one spring element and a means for deflecting the force, wherein the at least one means for deflecting the force is preferably designed as a movable roller which furthermore preferably has a groove for receiving the cable; and a stop; characterized in that the cable is fastened at one end directly or indirectly to the movable electrical conductor and at the other end directly or indirectly to the housing of the setting tool, and in that, in the inoperative state of the setting tool, the cable is tensioned by the tensioning device, by pretensioning of the spring element, so as to keep the movable electrical conductor pulled into an inoperative position defined by the stop, and wherein, during a setting operation, the movement of the movable electrical conductor further tensions the spring element via the cable, after which the spring element rebounds again to a pretensioned state and pulls the movable electrical conductor back into its inoperative position.

### TECHNICAL PROBLEM

Following a setting operation, the movable electrical conductor(s) must be reset into a known first starting position.

For setting tools having movable coils it is known to contact the movable coils with sliding contacts. However, these are subject to significant wear and reduce, with their impedance, the efficiency of such setting tools.

The object of the present invention is that of enabling simple resetting of the movable electrical conductor in the case of setting tools of this type, following a setting operation. Furthermore, in the case of such setting tools comprising a movable electrical coil, direct electrical (i.e. galvanic) contacting of the movable coil is intended to be made possible, and specifically without using sliding contacts.

### SOLUTION

This object is achieved by a setting tool according to claim 1. The setting tool comprises: at least one housing and an electrodynamic drive, wherein the electrodynamic drive comprises at least a first excitation coil, a movable electrical conductor, for example a squirrel-cage rotor or a second coil, which is arranged movably in the setting tool, a driving-in element, a cable, a tensioning device for the at least one cable, comprising at least one spring element and a means for deflecting the force, wherein the at least one means for deflecting the force is preferably designed as a movable roller which furthermore preferably has a groove for receiving the cable, and a stop and a stator, characterized in that the cable is fastened at one end directly or indirectly to the movable electrical conductor and at the other end directly or indirectly to the housing of the setting tool, and in that, in the inoperative state of the setting tool, the cable is tensioned by the tensioning device, by pretensioning of the spring element, so as to keep the movable electrical conductor pulled into an inoperative position defined by the stop, and wherein, during a setting operation, the movement of the movable electrical conductor further tensions the spring element via the cable, after which (i.e. after the setting operation) the spring element rebounds again to a pretensioned state and pulls the movable electrical conductor back into its inoperative position.

In this case, a reduced mass of the tensioning device including the cable is preferably at most half and preferably at most a quarter of the sum of the masses of the movable electrical conductor and the driving-in element. The reduced mass can be represented by m_{red}=m₁ m₂/(m₁+m₂) of the individual masses of the tensioning device, e.g. as the harmonic mean of the individual masses. The work performed by the drive is apparent largely as kinetic energy, divided over the piston mass (including electrical conductors) and the reduced mass m_{red} of the tensioning device.

The setting tool is preferably a handheld setting tool.

This object is furthermore achieved by a cable according to claim 4. The cable is for the setting tool according to the invention, in which the movable electrical conductor is designed as a movably arranged second coil, and is characterized in that the cable is designed to be at least two-core and has one or more means for radial strain relief, for example in the form of a sheathing of the cable, for absorbing repulsive Lorentz forces between the at least two cores. In this case, the cores must preferably be positioned as close together as possible, such that the self-induction of the line does not compromise the efficiency of the drive, because its initial self-induction (starting position) is very low, since the self-inductions of the two coils largely compensate one another.

The cable furthermore preferably comprises an axial strain relief means, which can be fastened directly or indirectly on the housing of the setting tool and on the movable second coil. As a result, an elongation of the cores (preferably highly flexible strand) can be prevented. In other words, it is thus possible to prevent the electrical conductors (cores) from having to absorb the significant tensile forces themselves.

The cable is furthermore preferably characterized in that its impedance is lower, and is preferably at least five times lower, than the impedance of a series connection of the first excitation coil and the movable electrical coil, when the drive is in its inoperative position. As a result, the reactive energy can be reduced to an acceptable amount. In particular, it is possible to prevent the setting energy from being reduced with the surface enclosed by the supply line (at the same conductor length).

### BRIEF DESCRIPTION OF THE FIGURES

FIG. 1a shows an embodiment of a drive according to the invention in its inoperative position.

FIG. 1b shows an embodiment of the drive according to the invention during a setting operation having a more strongly tensioned spring.

### DETAILED DESCRIPTION

The invention can be understood proceeding from the generally known “BX-3” nail setting tool of the manufacturer HILTI, the basic operating principle of which can be found for example in DE 10 2005 000 089 A1. This class of device initially tensions springs using an electric motor. For the setting, an unlocking mechanism is actuated, as a result of which the springs relax abruptly and can drive the driving-in element.

In this case, in BX-3 devices the springs drive the driving-in element not, for example, directly, but rather via a transmission which is formed by a roller pulley mechanism (also known as a “spring belt mechanism”). Thus, during a setting operation, in the case of BX-3 devices the springs relax and potential energy from the springs is—initially—converted via the roller pulley into kinetic energy of the driving-in element.

The present invention functions in exactly the opposite manner.

A setting tool according to the invention comprises at least
one housing;
a drive, comprising at least:
   a first excitation coil;
   a movable electrical conductor, for example a squirrel-cage rotor or a coil which is arranged movably in the setting tool;
   a driving-in element (e.g. a setting piston);
   a cable;
   a tensioning device for the at least one cable, comprising at least one spring element, it being possible for the spring to be for example a helical compression spring, a shaft ring spring, or a gas spring;
   a capacitor;
   a stop; and
   a stator.

In this case, the term cable is to be interpreted broadly-in the present case, ropes, belts, straps, bands, and chains are also to be understood as cables.

In the present case, a driving-in element, which can be designed in the manner of a piston, is to be understood as a body that is arranged movably in the setting tool and which can be directly or indirectly accelerated by a Lorentz force acting on the movable electrical conductor, in order to also directly or indirectly set a nail using its kinetic energy (and not only the kinetic energy of the movable electrical conductor).

The cable is fastened at one end directly or indirectly to the movable electrical conductor and at the other end directly or indirectly to the housing of the setting tool, said cable being tensioned by the tensioning device which can be designed in the manner of a roller pulley. In this case, the tensioning device is arranged such that it can pull the movable electrical conductor, with the forces of the spring element, by means of the at least one cable, into a first starting position (the inoperative position) in which the stop is active and in which the spacing between the movable electrical conductor and the first excitation coil is minimal. The stop can be adjustable and designed for example as a screw. However, it can also be fixed and formed for example by the first excitation coil, its casting compound, the stator itself, or the housing, or parts fastened on the housing, for example an electromagnetic shielding.

### Embodiment

For better understanding, the invention will be explained in the following with reference to an example. This explanation is in no way intended to be understood as being limiting, but rather is merely intended for better understanding of the invention.

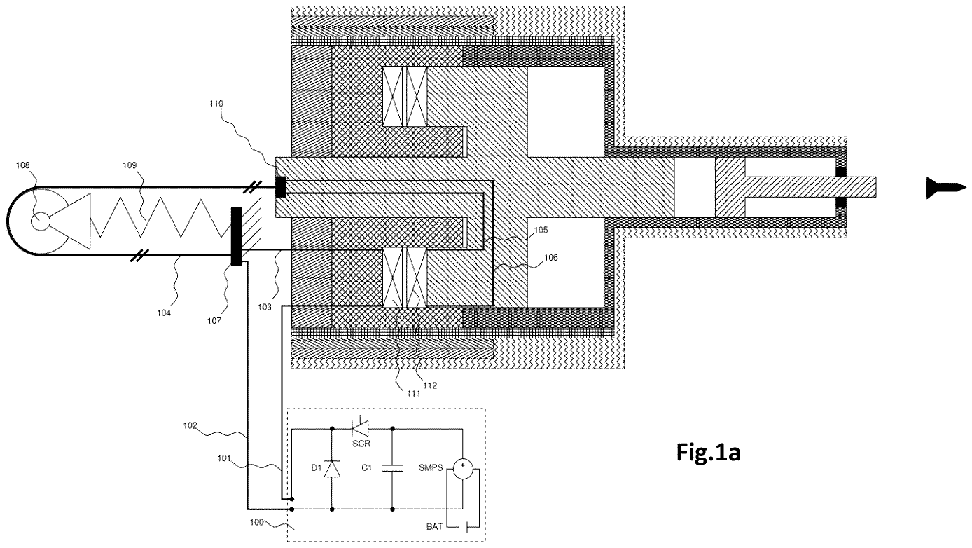

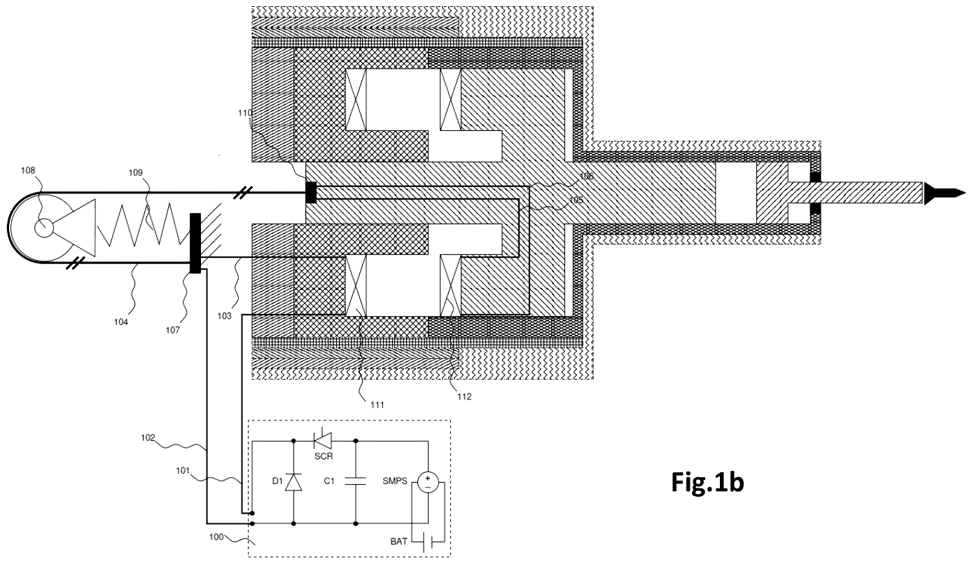

FIG. 1a shows, for example, an embodiment of a drive according to the invention in its inoperative position, comprising a first excitation coil 111 and an associated movable coil 112.

The drawing can be understood proceeding from the description of WO2020259870 and FIG. 7 therein. Said drive comprises an iron circuit (also “flux concentrator”), i.e. a body made of a magnetically soft material. Very preferably, the iron circuit has a saturation flux density of at least 1 T, preferably at least 1.5 T, and more preferably at least 1.9 T, and in particular an effective electrical conductivity of at most 10 6 S/m, more preferably at most 10 5 S/m and more preferably at most 10 4 S/m; various magnetically soft composite materials fulfil these requirements. Owing to their brittleness, preferably a magnetically soft composite material is used for the iron circuit, which is optionally segmented by a person skilled in the art in order to prevent tearing. The segmenting thus serves the purpose of preventing the tensile strength (and preferably also the yield strength) of the magnetically soft composite material from being exceeded locally during a setting operation.

The drive piston is preferably formed entirely or largely from a plastics material, in particular a glass fiber-filled liquid crystal polymer, which can be designed to have at least one guide axis. More preferably, the drive piston is formed entirely or in part from a technical ceramic, which has a high mechanical toughness, high thermal conductivity, but low electrical conductivity, such as beta-Si3N4 but also short fiber-reinforced SiSiC.

The drive preferably comprises a setting piston having a piston rod, drive-in energy being transmitted from the setting piston to the nail via the piston rod.

A base plate preferably consists of magnetically soft solid material, in particular a ferritic steel, which serves for shielding (EMV, EMVU) and as a heat sink.

A pipe made of CRP preferably serves for strain relief of the iron circuit and for centering.

Furthermore, a pipe made of an aluminum alloy can be provided, which preferably has as high as possible an electrical conductivity, and which, in the present case, serves for shielding electromagnetic alternating fields.

The tubular magnetically soft material preferably has a high saturation flux density and consists in particular of ferritic steel. This serves for shielding electromagnetic direct current fields.

In order to set a nail or bolt into a substrate using the arrangement shown symbolically in FIG. 1a, firstly the capacitor CI is charged via the switch convertor SMPS (in the case of a battery-operated setting tool of course with the aid of electrical energy from the battery/batteries BAT). The capacitor CI should have the highest possible energy density and the lowest possible electrical series resistance, and a particularly high short-circuiting resistance. Corresponding capacitors are commercially available as film capacitors, especially for pulse applications.

After the desired charging voltage has been reached via C1, the thyristor SCR can be ignited for setting a nail. Current now flows via the cores into the excitation coil and the movable electrical conductor (squirrel-cage rotor or coil). Both are preferably connected in series, and specifically such that the current in the excitation coil and the movable electrical conductor flows in opposite directions during the setting operation, and thus do not repel one another. For the coils, Cu ribbon wire is possible in particular, in order to achieve the highest possible degree of filling at minimal electrical resistance.

In this case, the cores (supply lines) 101 and 103 can be guided directly through the piston and/or its (rear) “guide axis”; very preferably, the supply lines consist of an aluminum alloy or copper, in particular in the form of fine, highly flexible strands, and are strain-relieved outside of the piston 720, for example with the aid of carbon fibers or carbon fiber fabric. What is essential is that the strain relief means connected mechanically in parallel with the supply lines consists of a material having sufficient tensile strength—i.e. which does not tear under the given conditions—and has a higher tensile modulus than the electrical supply lines themselves, which it is intended to relieve. In this case, the strain relief means is preferably designed to protect the electrical conductors from a tensile stress (during or on account of a setting operation), which exceeds their yield strength, or even tensile strength. More preferably, the material of the strain relief means has a high specific strength. Carbon fibers and their fabric may fulfil these requirements. The drive piston (first piston) can be designed to form a decoupling device, together with the setting piston (second piston) and cylinder.

The capacitor C1 can be charged, by means of the switch converter SMPS, from a battery, in particular a lithium-ion accumulator, and discharged by means of the thyristor SCR via the cores 101 and 102 via the drive, which exhibits pronounced ohmic inductive behavior, as a result of which a freewheeling diode D1 is provided.

The core 101 is guided to the input of the first excitation coil 111, which is arranged and fastened on the pot-shaped stator. A person skilled in the art understands a core to be a single electrical line (e.g. in comparison with the plurality of cores in a cable). A core is for example a strand.

From the output of the coil, the core is guided as the core 103 to a strain relief means 107. The core 102 is guided directly from the surge current supply 100 to the strain relief means 107.

Both cores are then guided in a common cable 104 which is connected in a form-fitting, force-fitting or integral manner to the strain relief means 107, such that an introduction of mechanical tensile stresses in the first excitation coil 111 and surge current supply 100 is prevented or at least reduced.

The cable 104 comprises at least two cores which are current-carrying, at least at times, during operation, and which preferably consist of a highly flexible Cu or Al strand and/or of single-layer or, preferably, multi-layer metal foils or metal films, i.e. the continued cores 102 and 103. If a core consists of a multi-layer metal film or multi-layer metal foil, then the individual layers are preferably insulated from one another, for example by an elastomeric polymer.

The cores 105 and 106 are preferably strain-relieved, in order to reduce the introduction of tensile stresses into the movable coil. They are preferably guided within the anchor rod to the coil, in order to prevent tilting moments (on the piston). More preferably, they are in addition also cast or adhesively bonded within the anchor rod.

The cable 104 is designed such that the cores 102 and 103 are reliably electrically insulated from one another. Furthermore, the cable 104 comprises its own radial strain relief means.

The radial strain relief means absorbs the repelling forces between the cores 102 and 103 arising during the energization of the drive, and consists for example in that a tension-proof fabric is braided around the cable. In addition, a wear-resistant tube can also be shrunk or clad onto the cable.

Furthermore, the cable 104 can comprise its own axial strain relief means. Such an intrinsic axial strain relief means of the cable 104 can consist, for example, of a third core made of a tension-proof fabric or tension-proof strand, which highly preferably has a higher tensile modulus than the metal conductor(s) selected for the cores 102 and 103. Said axial strain relief means can be connected to the strain relief means 107, such that arising tensile forces do not have to be entirely or largely transmitted via the cores 102 and/or 103.

The cable 104 is then guided via a force deflection means, which, in the example, consists of a roller 108, arranged movably along the setting direction. Instead of a roller, for example a cam disc could also be used, on which the cable 104 can slide. In the example this is, as mentioned, a roller which can comprise a groove for receiving the cable and in which the cable comes to rest. Alternatively, the roller 108 can, in contrast to a groove, exhibit an outward curvature, and be wound around the cable 104, then designed as a belt, in a self-centering manner.

On the side of the drive, the cable 104 is connected to the strain relief means 110. This in no way has to be formed as a discrete component, but rather can also consist, for example, in that the cable 104 is adhesively bonded or mechanically connected in another way (in a form-fitting, integral or force-fitting manner) to another component connected to the movable coil 112.

Proceeding from the strain relief means 110, the two electrical cores of the cable 104 are connected to an input and output of the movable coil 112. This enables, in a simple manner, an electrical series connection of the stator coil 111, i.e. the first excitation coil, and the movable coil 112, these being connected in series in such a way that they are energized opposingly upon discharge of the capacitor C1. A series connection of this kind is advantageous, but a parallel connection is also possible.

A spring element 109, for example a helical compression spring, shaft ring spring or gas spring, tensions the cable 104 via the movable roller 108 and can, as long as no setting takes place, pull the movable electrical conductor, i.e. the movable second coil 112, into the initial position shown in FIG. 1a, via the piston.

During a setting operation initially the first excitation coil 111 and movable second coil 112 repel one another, as a result of which force is transmitted to the roller 108 via the cable 104 in order to tension the spring element 109. In this case, a reduction takes place, in the manner of a roller pulley, to the effect that the roller 108 moves at only (approximately) half the speed, according to the reduction ratio, of the movable electrical conductor.

For improved understanding, FIG. 1b shows the same drive during a setting operation having a more strongly tensioned spring.

After completion of the setting operation, the movable electrical conductor, in the present case the second coil 112, is pulled back via the cable 104 as far as the stop, into its starting position shown in FIG. 1a.

1. A setting tool, comprising:
at least one housing and an electrodynamic drive, the electrodynamic drive comprising:
a first excitation coil;
a movable electrical conductor arranged movably in the setting tool;
a driving-in element;
a cable fastened at one end directly or indirectly to the movable electrical conductor and fastened at another end directly or indirectly to the at least one housing;
a tensioning device for the cable, the tensioning device comprising at least one spring element and a means for deflecting a force; and
a stop,
wherein in an inoperative state of the setting tool, the cable is tensioned by the tensioning device, by pretensioning of the at least one spring element, so as to keep the movable electrical conductor pulled into an inoperative position defined by the stop, and, during a setting operation, a movement of the movable electrical conductor further tensions the at least one spring element via the cable, after which the at least one spring element rebounds to a pretensioned state and pulls the movable electrical conductor back into the inoperative position.

2. The setting tool according to claim 1, wherein a reduced mass of the tensioning device including the cable is at most half of a sum of masses of the movable electrical conductor and the driving-in element.

3. The setting tool according to claim 1, wherein the setting tool is a handheld setting tool.

4. The setting tool according to claim 1, wherein the movable electrical conductor is designed as a movably arranged second coil and the cable is designed to include at least two cores and has one or more means for radial strain relief for absorbing repulsive Lorentz forces between the at least two cores.

5. The setting tool according to claim 4, wherein the cable further comprises an axial strain relief means, which can be fastened directly or indirectly on the at least one housing of the setting tool and on the movably arranged second coil.

6. The setting tool according to claim 4, wherein an impedance of the cable is lower than an impedance of a series connection of the first excitation coil and the movably arranged second coil, when the electrodynamic drive is in an inoperative position.

7. The setting tool according to claim 1, wherein the movable electrical conductor comprises a squirrel-cage rotor or a second coil.

8. The setting tool according to claim 1, wherein the means for deflecting a force comprises a movable roller.

9. The setting tool according to claim 8, wherein the means for deflecting a force comprises a groove for receiving the cable.
